(19) United States
(12) Patent Application Publication
(10) Pub. No.: US 2005/0248653 A1
(43) Pub. Date: Nov. 10, 2005

(54) Camera device with unitary interface cabling

(76) Inventor: Jack Hoang, Toronto (CA)

Correspondence Address: TIMOTHY CORDER;Vinson and Elkins LLP, Ste 100, 2801 Via Fortuna, Austin, TX, 78746, US

(21) Appl. No.: 11/123,842

(22) Filed: May 6, 2005

Related U.S. Application Data
(60) Provisional application No. 60/568,678, filed on May 7, 2004.

(51) Int. Cl. H04N 7/18

(52) U.S. Cl. 348/143

(57) ABSTRACT

A camera device with unitary interface cabling has a built-in balun for converting unbalanced video signal to balanced video signal for transmission from an on-board twisted pair video output connector, a power connector, a PZT control signal connector, and all said connectors adapted for linking with a category 5 of better network cable.

### CROSS-REFERENCE TO RELATED APPLICATION

This application claims the benefit under 35 USC §119(e) of the following patent application, the disclosure of which is hereby incorporated by reference thereto in its entirety: U.S. Ser. No. 60/568,678 filed May 7, 2004.

### TECHNICAL FIELD OF THE INVENTION

This invention is related to the field of video cameras, more specifically to a camera with unitary interface cabling.

### BACKGROUND OF THE INVENTION

Digital video camera systems have many uses, in particular for surveillance or monitoring purposes. For example, such a camera system can be placed near an automatic teller machine (ATM), a cash register or a point of sales device (POS), or in the proximity of doorways of facilities such as office buildings or factories. Other applications include monitoring the entire duration of a process or operation.

Any unauthorized acts or irregularity may be identified and followed up using the digital images captured with such a camera system.

Although a number of existing cameras have on-board memory for the captured images, for long term monitoring or surveillance (hours if not days), a typical digital camera system is connected to a digital video recorder (DVR) or a video cassette recorder (VCR for analog signals) for large capacity storage of captured images. This connection is via a co-axial cable with BNC or TNC plugs. RG58, RG59 or RG6 co-axial cables have the disadvantage of requiring amplification for longer distances (over a few hundred feet) due to loss of high frequency signal drop.

Sophisticated versions of such camera systems possess pan-tilt-zoom capability under digital electronic control. The image capturing and processing elements of such a system including the lens are mounted such to have the centre of the field of view mechanically pointed at different pan-tilt angles. The images may be optically or digitally zoomed.

Although PTZ control can be done manually, as for example using switches or toggles on the camera system, typically, the camera system receives digital PTZ instructions via a telecommunication connection from a server on a network under the control of a human user. (The server may also issue PTZ instructions to move the camera either continuously or periodically to cover a larger surveyed or monitored field.)

Power to the camera system is provided from a power outlet.

As a result, a typical camera system requires 3 separate cables for: (1) video output, (2) PTZ control; and (3) power. Such a system would be cumbersome and costly to install and manage. For example, for a system with 16 camera systems in a surveillance network, a technician would have to use 48 cables, perhaps over several thousand feet of distance.

### SUMMARY OF THE INVENTION

The invention has the object of providing a camera system with a minimal number of interface cables.

This invention provides a camera device with unitary interface cabling having a built-in balun for converting unbalanced video signal to balanced video signal for transmission from an on-board twisted pair video output connector, a power connector, a PZT control signal connector, and all said connectors adapted for linking with a category 5 network cable.

Additionally, the video signal can be converted to a digital signal in the camera prior to transmission.

This invention provides a camera device with greatly reduced wire requirements with acceptable loss ratios for ranges up to 1000 feet using category 5 network cable without additional amplification. The camera connection is much simpler, and the signal is easily reconverted using another balun at the receiving end of the category 5 network cable. The modification of existing video cameras to transmit power, video and control signals over standard network cabling creates a useful standard for digital surveillance video management systems.

### BRIEF DESCRIPTION OF THE DRAWINGS

FIG. 1 is a perspective view of a preferred embodiment of the invention with an interface cable.

FIG. 2 is a rear view of the camera system of a preferred embodiment showing connectors for the unitary interface cable and optional controls and co-axial signal connector.

FIG. 3 is a schematic of the internal connection between the camera and the cabling interface for connection to category 5 network cables.

### DETAILED DESCRIPTION OF THE INVENTION

A detailed description of the embodiments of the invention will now be provided with specific reference to the drawing illustrating a preferred embodiment of the invention. Like structures will be provided with like reference numbers.

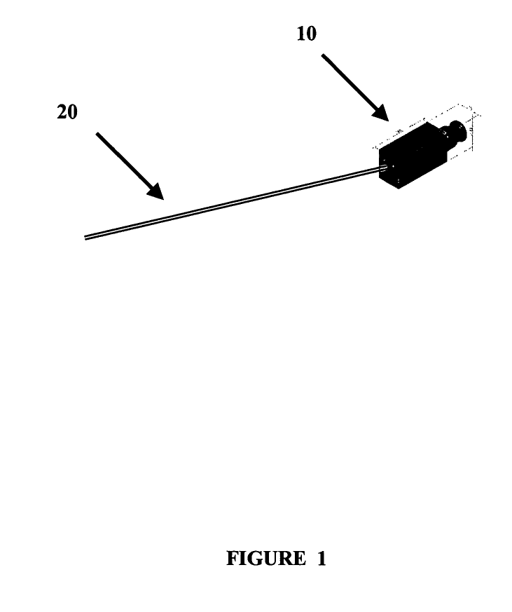

FIG. 1 is a perspective rear view of a preferred embodiment of the invention showing a single interface cable 20 connected to a camera system 10 of the subject invention. The interface cable 20 is preferably a category 5 cable with 4 twisted pairs of wiring. Higher grade network cabling can also be used in the spirit of the immediate invention, with modifications to the connection interface, or by using adapters to convert the available wire connection to one compatible with category 5.

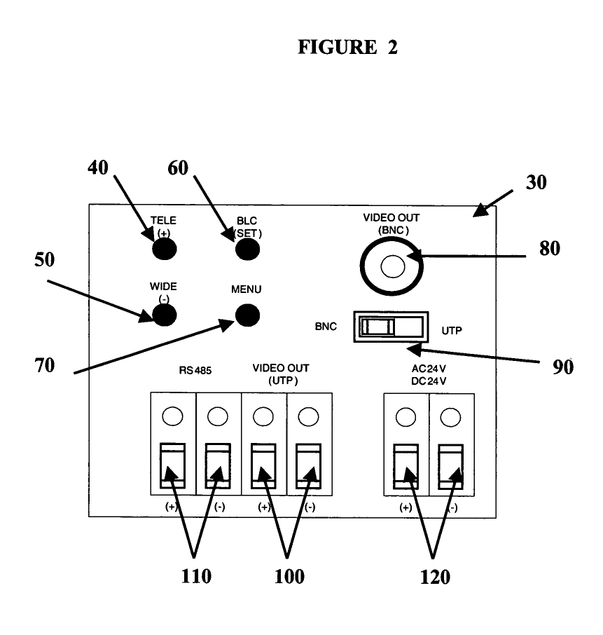

FIG. 2 is a rear view of a preferred camera system 10 showing a possible set of switches and terminals on a rear panel 30. The top part of the panel contains a number of optional elements. A TELE element 40 provides manual control for increased magnification of an image in the field of view (zooming into the image). A WIDE element 50 provides manual control for lower magnification (zooming out). These two elements 40 50 are preferably button-type controls.

Backlight compensation (BLC) for improved image quality where there is a bright light source in the image background may be manually turned on or off by using the BLC switch 60. A menu switch 70 serves to permit selecting from a menu (not shown). A co-axial video output connector 80 (a BNC connector) is included for transmitting video output signals down a co-axial cable. However, a user may manually elect between transmitting video output in this fashion or down a twisted-pair cable using a output selector 90.

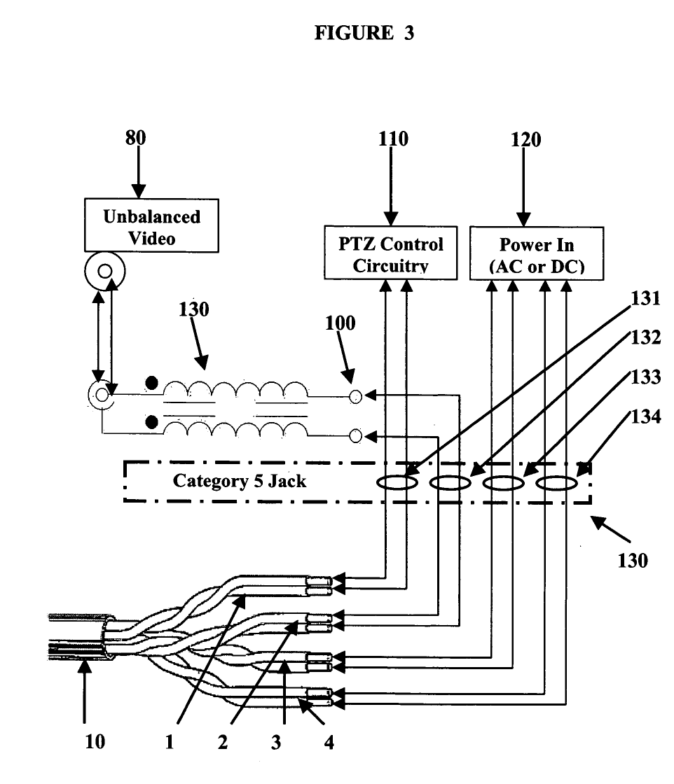

The basic configuration of the preferred embodiments includes a number of elements then shown in FIG. 2. A balun (shown in FIG. 3) converts unbalanced video output signal generated for transmission down a co-axial cable to a balanced signal for a twisted pair cable (typically using 24 AWG wires). The converted signal is sent through the twisted pair video output connector 100 (shown as a pair of terminals in FIG. 2 but not limited to such). PTZ control signal is received by the camera system 10 through a PTZ signal connector 110 (shown as a pair of terminals in FIG. 2 but not limited to such), corresponding to the Rx pins

Balun technology has resulted in audio-video performance for twisted pair wired transmission that is comparable to coaxial cable wired systems and in some instances surpass co axial cable in terms of distance. This is due primarily to twisted pair's noise cancellation effect when the video is transmitted as a balanced signal.

Power for the camera system 10 is received by a power input connector 120 (shown in FIG. 2 as a pair of terminals). This is preferably of 24V AC/DC compatible type.

Embodiments of this invention include or are capable to use a single interface cable 20 including at least 4 conductor (wire) pairs for sending PTZ control signal and electrical power to, and receiving video signal from, the camera system 10. This interface cable 20 is preferably a category 5 network cable, with 4 pairs of wires (at least 22, preferably 24, AWG). One wire pair is attached to each of the twisted pair video output connector 100 and the PTZ signal connector 110; One pair is connected to the positive and the other pair to the negative terminals of the power input connector 120.

In preferred embodiments, there may be a pair of plug and receptacle (jack) that provides the link between the interface cable 20 and the camera system 10. Such a plug may be of any suitable type such as RJ45, DB9, DB25, and etc. In this fashion, removal and installation of a camera system 10 is made easier and faster.

FIG. 3 shows a schematic of how the network cable 20 comprising 4 twisted pairs 21, 22, 23, and 24 may be connected through an optional standard category 5 network jack. Internally, the jack 130 is connected to PTZ signal connector 110 at jack connection pair 131 such that twisted pair 21 makes a connection with the PTZ controller. Internally, the jack 130 is connected to the balanced video output connector 100, at jack connection pair 132 such that twisted pair 22 makes a connection with the video output connector 100, which is itself connected internally to the co-axial video output connector 80 via an appropriated balanced balun 130. The jack 130 is connected to the input power lines 120 of the camera at jack connection pairs 133 and 134, such that twisted pair 23 and twisted pair 24 can make a power signal connection with the power input connector 120. Where it is known in advance that a particular camera will always be connected in this fashion, these connections may all be made internally, and connectors 80, 100, 110 and 120 covered by a plate (not shown) featuring only the network cable jack 130. A plate, bearing a jack, the tuned balun and wiring can be provided as a kit to convert existing cameras to this standard. The jack 130 is typically of any suitable type such as RJ45, DB9, DB25, with a corresponding plug (not shown) on the cable 20. The RJ45 standard has 8 pins or 4 pairs of pins. Without loss of generality, we refer to the connections on the male and female plugs as pins. Typically, a technician would have the male plug on the cable and the female plug on the device, but it would be within the scope of this invention to make the obvious reversal.

The interface cable 20 is connected on the other end to a source of electrical power, a source of PZT control signals, and a receiver for the video signal. The receiver preferably includes a converter for changing the balanced signal from the camera system 10 to an unbalanced signal for feeding to a DVR system (which may also incorporate the PZT control signal generator). As at the camera system 10 end, a pair of plug and receptacle may provide a easily disengageable link between the interface cable 20 and the sources of electrical power and PZT control instructions, and the video signal receiver.

It will be appreciated that the above description relates to the preferred embodiments by way of example only. Many variations on the system for delivering the invention will be clear to those knowledgeable in the field, and such variations are within the scope of the invention as described and claimed, whether or not expressly described. In particular, it will be noted that the preferred embodiments of the invention only require twisted pair network cable comprising at least 4 pairs. While category 5 cabling is specifically mentioned, category 5 enhanced, category 6, category 7 (planned) and other shielded or unshielded cabling may be used. The key import being that the balun must be balanced to the cable to allow full range benefits.

1. A conversion kit for use with a video camera having control circuitry for pan tilt zoom (PZT) control featuring a PZT control input, a power input, and a video output for supplying an unbalanced video output signal, wherein the kit comprises:
(a) A network jack having at least 4 pairs of pins capable of connecting to a network cable comprising at least 4 twisted pairs, each pair of pins having a first pin and a second pin;
(b) A control system connector for connecting a first pair of pins on the network jack to the PZT control input;
(c) A set of power lines for connecting the third and fourth pair of pins on the network jack to the power input; and
(d) A balun connected to the second pair of pins on the network jack for connecting to the video output, for converting the unbalanced video output signal to a balanced video output signal.

2. The conversion kit for use with a video camera of claim 1 wherein the power input has a positive power connector and a negative power connector and at least one of the first and second pins of the third pair of pins is connected to the positive power connector and at least one of the first and second pins of the fourth pair of pins is connected to the negative power connector.

3. The conversion kit for use with a video camera of claim 1 wherein the power input connector has a positive power connector and a negative power connector and the first pin of the third pair of pins is connected to the positive power connector and the second pin of the third pair of pins is connected to the negative power connector.

4. The conversion kit for use with a video camera of claim 4 wherein the network jack is chosen from the group consisting of RJ45, DB9, DB25 standard network connectors.

5. The conversion kit for use with a video camera of claim 1 wherein the network cable is selected from the group consisting of category 5 network cable (Cat5), category 5 enhanced network cable (Cat5e), category 6 network cable (Cat6) and category 7 network cable (Cat7).

6. The conversion kit for use with a video camera of claim 2 wherein the network cable is selected from the group consisting of category 5 network cable (Cat5), category 5 enhanced network cable (Cat5e), category 6 network cable (Cat6) and category 7 network cable (Cat7).

7. The conversion kit for use with a video camera of claim 3 wherein the network cable is selected from the group consisting of category 5 network cable (Cat5), category 5 enhanced network cable (Cat5e), category 6 network cable (Cat6) and category 7 network cable (Cat7).

8. The conversion kit for use with a video camera of claim 4 wherein the network cable is selected from the group consisting of category 5 network cable (Cat5), category 5 enhanced network cable (Cat5e), category 6 network cable (Cat6) and category 7 network cable (Cat7).

9. A unitary interface cabling system for a video camera having control circuitry for pan tilt zoom (PZT) control featuring a PZT control input, a power input, and a video output for supplying an unbalanced video output signal, wherein the unitary interface cabling system comprises:
(a) Connecting the PZT control input to a first twisted pair of wires in a network cable having at least 4 twisted pairs;
(b) Connecting the video output to a balun capable of balancing the unbalanced video signal and connecting the output of the balun to a second twisted pair of wires in the network cable; and
(c) Connecting the power input to a third pair of wires or a fourth pair of wires in the network cable.

10. The unitary interface cabling system of claim 9 wherein the power input has a positive power connector and a negative power connector and at least one of the wires in the third twisted pair is connected to the negative power connector and at least one of the wires in the fourth twisted pair is connected to the positive power connector.

11. The unitary interface cabling system of claim 10 wherein the second twisted pair has an input end connected to the balun connected to the camera and an output end connected to a second balun connected to a video signal receiver capable of receiving unbalanced video signals.

12. The unitary interface cabling system of claim 11 wherein the network cable is selected from the group consisting of category 5 network cable (Cat5), category 5 enhanced network cable (Cat5e), category 6 network cable (Cat6) and category 7 network cable (Cat7).

13. A method of connecting a video receiver to a video camera having control circuitry for pan tilt zoom (PZT) control featuring a PZT control input, a power input, and a video output for supplying an unbalanced video signal, using a network cable having at least 4 twisted pairs of wires; the method comprising the steps of:
(a) Connecting the PZT input to a first twisted pair of wires of a network cable having at least 4 twisted pairs or wires, thereby defining a network cable camera end and a network cable receiver end;
(b) Connecting the video output to an input of a balun capable of balancing the unbalanced video signal to the network cable, and connecting an output of the balun to a second twisted pair of wires of the network cable at the network cable camera end;
(c) Connecting the power input to a third twisted pair of wires or a fourth twisted pair of wires of the network cable at the network cable camera end;
(d) Connecting the first twisted pair of wires of the network cable at the receiver end to a PTZ control signal;
(e) Connecting the second twisted pair of wires of the network cable at the receiver end to balun capable of unbalancing the video signal for connection to the video receiver; and
(f) Connecting the third twisted pair of wires or fourth twisted pair of wires of the network cable at the receiver end to a power supply.

14. The method of claim 13 wherein the power input has a positive power connector and a negative power connector and step ((c)) further comprises connecting at least one of the wires in the third twisted pair of wires to the positive power connector and connecting at least one of the wires in the fourth twisted pair of wires to the negative power connector.

15. The method of claim 13 wherein the power input has a positive power connector and a negative power connector and step ((c)) further comprises connecting at least one of the wires in the third twisted pair of wires to the negative power connector and connecting at least one of the wires in the fourth twisted pair of wires to the positive power connector.

16. The method claim 14 wherein the network cable is selected from the group consisting of category 5 network cable (Cat5), category 5 enhanced network cable (Cat5e), category 6 network cable (Cat6) and category 7 network cable (Cat7).

17. The method of claim 15 wherein the network cable is selected from the group consisting of category 5 network cable (Cat5), category 5 enhanced network cable (Cat5e), category 6 network cable (Cat6) and category 7 network cable (Cat7).

18. A camera device comprising control circuitry for pan tilt zoom (PZT) control featuring a PZT control input, a video output for supplying an unbalanced video signal, a balun for balancing the unbalanced video signal, and a power input having a negative power connection and a positive power connection, and wherein the improvement is characterized by the camera further comprising a standard 4 twisted pair network jack such that:
(a) the PZT control input is connected to a first pair of pins in the network jack corresponding to the first twisted pair,
(b) the output of the balun is connected to a second pair of pins in the network jack corresponding to the second twisted pair,
(c) the negative power connection is connected to one of (i) a third pair of pins in the network jack corresponding to the third twisted pair or (ii) a fourth pair of pins in the network jack corresponding to the fourth twisted pair; and
(d) the positive power connection is connected to whichever of the third slot in the network jack or the fourth slot in the network jack not connected to the negative power connection.

19. A camera device of claim 18 wherein the network cable is selected from the group consisting of category 5 network cable (Cat5), category 5 enhanced network cable (Cat5e), category 6 network cable (Cat6) and category 7 network cable (Cat7) and the network jack is selected from the group consisting of the group consisting of RJ45, DB9, DB25 standard network connectors.
